(19) United States
(12) Patent Application Publication
(10) Pub. No.: US 2009/0295538 A1
(43) Pub. Date: Dec. 3, 2009

(54) SYSTEM AND METHOD FOR PRELOADING INDIVIDUAL PARAMETERS

(75) Inventors: Chi-Lu YANG, Tainan (TW); Ming-Zoo WU, Taichung (TW); Chih-Ping CHU, Tainan (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: INSTITUTE FOR INFORMATION INDUSTRY, Taipei City (TW)

(21) Appl. No.: 12/174,328

(22) Filed: Jul. 16, 2008

(30) Foreign Application Priority Data
May 27, 2008 (TW) 097119579

(51) Int. Cl. G06F 7/04

(52) U.S. Cl. 340/5.82

(57) ABSTRACT

A system and a method for preloading individual parameters are presented. The system includes a server, a labeling device, an intermediate device, and a measuring device. The server is used for storing a plurality of individual parameters, and the labeling device is used for recording user characteristic data. In the method, the intermediate device detects a position of the labeling device, obtains the user characteristic data thereof, and downloads the matching individual parameter from the server. Afterward, when it is detected that the measuring device is actuated and the labeling device is determined to be located at a particular position on the periphery of the measuring device, the individual parameter matching the user characteristic data of the labeling device is output to the measuring device for setting. Thereby, the present invention saves the trouble for users moving with difficulty to log in the server, and simplifies the operation.

This application claims the benefit of Taiwan Patent Application No. 097119579, filed on May 27, 2008, which is hereby incorporated by reference for all purposes as if fully set forth herein.

### BACKGROUND OF THE INVENTION

1. Field of Invention

The present invention relates to a value loading system, and more particularly to a system and a method for preloading individual parameters capable of downloading individual parameters of a user in advance and then identifying a device user to immediately load the corresponding individual parameter.

2. Related Art

Referring to FIG. 1, in the prior art, a nursing system includes a physiological server 101, a nursing device 102, and a measuring device 103. First, a user logs in the physiological server 101 through the nursing device 102, then obtains related device parameters to be loaded to the parameters in the measuring device 103 for setting. As such, the measuring device 103 is adopted to measure the physiological status of the user to form a related physiological data. Finally, the nursing device 102 feeds back the physiological data to the physiological server 101, so as to facilitate the nursing personnel inspecting and tracking the state of an illness.

However, the prior art has the following indispensable defects.

1. As the nursing device generally provides a manual login, it is awkward for patients moving with difficulty. Further, it is also inconvenient for patients with an eye disease or illiterate to log in always under other people's help.

2. As the nursing device is generally set with a fixed account number, or the account number stored in the server is corresponding to a certain nursing device, the users can only log in through their own nursing devices, and are unable to use any other nursing devices. Therefore, the adaptability of the system is very much limited.

3. As the device setting of a measuring device is corresponding to the account number or nursing device of a user, the device setting can be downloaded by a nursing device is fixed, and the device setting cannot be downloaded to other nursing devices at will. Further, professional engineers have to modify the inner setting of the nursing device, so the system has very limited expansibility in the measuring device and the process is complicated. Therefore, it is rather inconvenient for the user.

### SUMMARY OF THE INVENTION

Accordingly, in order to solve the above problems, the present invention is directed to a system and a method for preloading individual parameters capable of downloading individual parameters of a user in advance, and then inputting the individual parameter corresponding to the user to a measuring device when employed by the user, so as to simplify the login and measuring processes for the user.

In order to solve the above problems regarding system, a system for preloading individual parameters is provided. The system includes a server, at least one labeling device, an intermediate device, and at least one measuring device.

The server is used for storing a plurality of individual parameters, and each of the labeling devices records a user characteristic data. The intermediate device is connected to the server and the measuring device, for detecting the labeling device in a detection range thereof to obtain the user characteristic data of the labeling device, and acquiring the individual parameter matching all the user characteristic data from the server. Afterward, on detecting that the measuring device is actuated and determining that the labeling device is located at a particular position on the periphery of the measuring device, the intermediate device analyzes the user characteristic data of the labeling device located at particular position, and outputs the corresponding individual parameter to be set by the measuring device.

In order to solve the above problems regarding method, a method for preloading individual parameters is provided. First, an intermediate device is employed to detect at least one labeling device, determine a position of the labeling device, and obtain a user characteristic data recorded by the labeling device. Next, at least one individual parameter matching the user characteristic data is downloaded from the server. Afterward, the intermediate device is employed to analyze whether only one labeling device is located at a particular position on the periphery of a measuring device when it is determined that the measuring device is actuated, and if no, a selection rule is adopted to select the labeling device located at the particular position. Finally, according to the user characteristic data of the labeling device at the particular position, the individual parameter corresponding to the user characteristic data is output to the measuring device.

In addition, the method of the present invention can also be embodied by a recording medium. Program codes recorded in the recording medium are read and executed to achieve the same efficacies as the method for solving the above problems.

The present invention has the following efficacies superior to the prior art.

1. After detecting the existence of a user, the intermediate device automatically loads related individual parameters, and the user login and device setting processes can be omitted. When applied to a nursing system, the present invention is beneficial to patients moving with difficulty, illiterate, or having an eye disease, thus enhancing the utility of the nursing system.

2. There is no need to preset an account number to the intermediate device. On detecting the existence of the labeling device, the intermediate device downloads related individual parameters in advance. Moreover, the intermediate device can be used by users at any time any place, thus improving the adaptability of the system.

3. As the intermediate device downloads the individual parameters of the user in advance, related individual parameters can be immediately loaded and set in the measuring device when employed by the user, instead of being downloaded from the server after the user logs in. Thereby, the time for the user to get accustomed to the system and the time for setting the measuring device are greatly reduced.

4. The system is applicable to different environments. For instance, when used in a nursing system, the intermediate device is a nursing device (such as a healthcare box available in the market), and the measuring device is a physiological measuring device such as a blood-pressure meter, blood-glucose meter, oximeter, or respirometer. When applied to an exercising system, the measuring device is an electronic exercising equipment such as an electronic weight lifting machine or electronic running machine, and the intermediate device is a wireless network device, so as to download corresponding types of individual parameters according to the status of the electronic exercising equipment in use. Meanwhile, the exercising system is applicable to different types of exercising programs for training athletes. Moreover, when applied to an office system, the measuring device is a computer of different types, the intermediate device is a wireless network device, and the server stores office status data of various users. To be specific, the wireless network device downloads related status data, so that when the user operates on any computer, corresponding office status data is loaded for the user to continue the unfinished work. Thereby, the adaptability of the system is greatly enhanced.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a system configuration according to the prior art;

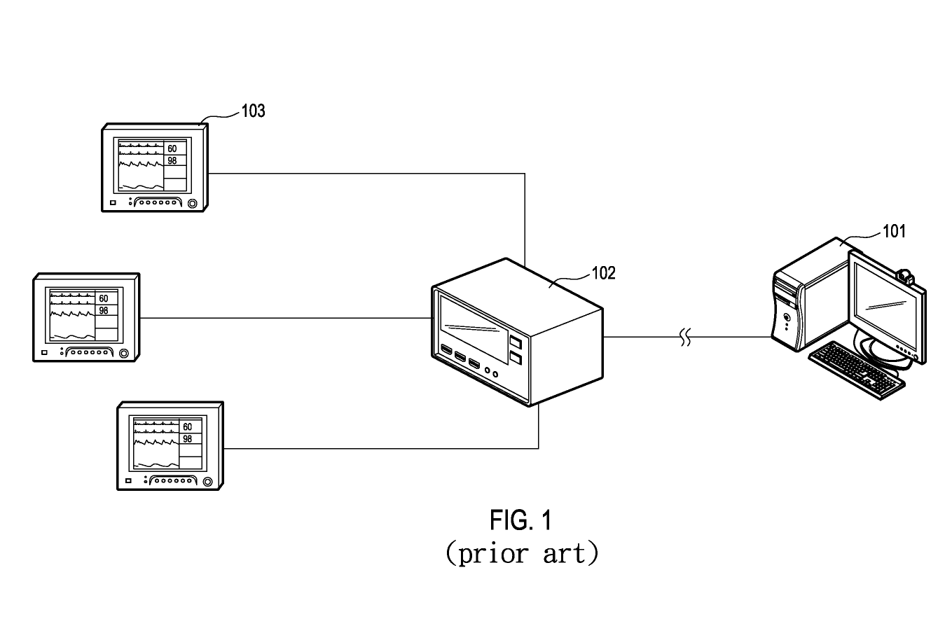

FIG. 2A is a schematic architectural view of a system according to a first embodiment of the present invention;

FIG. 2B is a schematic block diagram of the system according to the first embodiment of the present invention;

FIG. 3A is a schematic flow chart of a method according to the first embodiment of the present invention;

FIG. 3B is a schematic partial flow chart of the method according to the first embodiment of the present invention;

FIG. 4A is a schematic architectural view of the system according to a second embodiment of the present invention;

FIG. 4B is a schematic block diagram of the system according to the second embodiment of the present invention; and

FIG. 5 is a schematic architectural view of the system according to a third embodiment of the present invention.

### DETAILED DESCRIPTION OF THE INVENTION

The objectives, structures, features, and functions of the present invention will be illustrated in detail below in the accompanying embodiments.

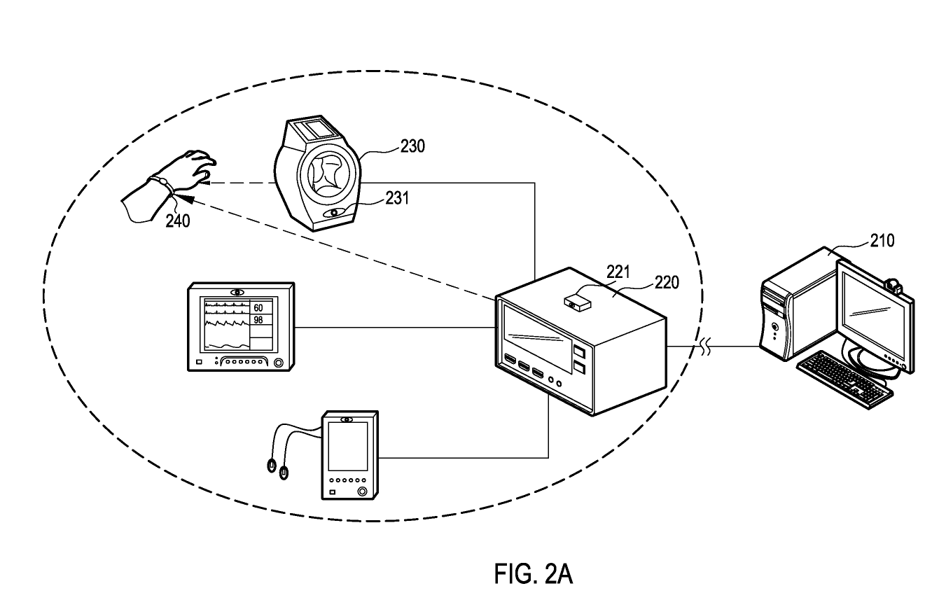

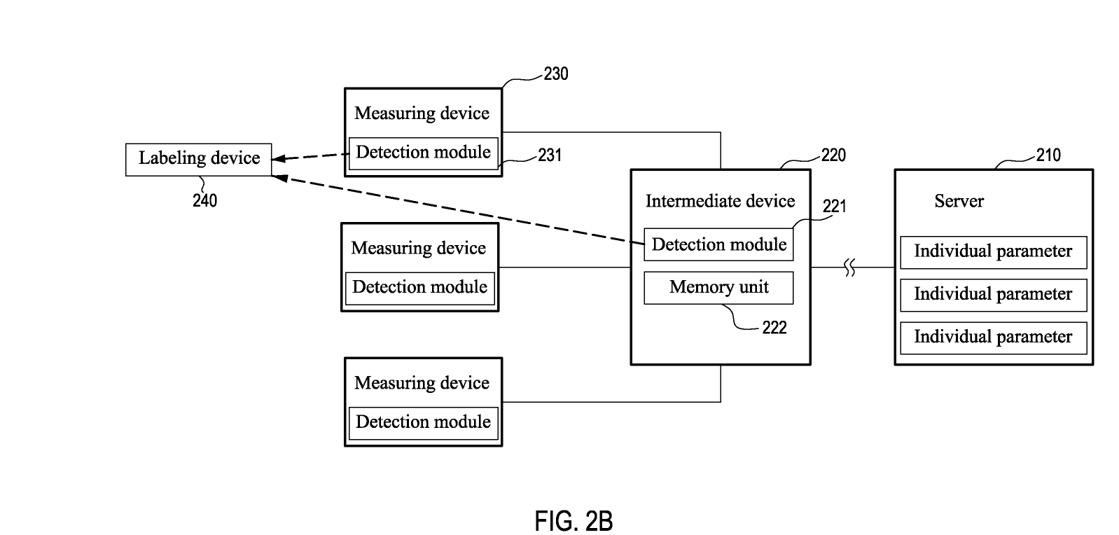

Together referring to FIGS. 2A and 2B, a schematic architectural view and a schematic block diagram of the system according to a first embodiment of the present invention are respectively shown. The system includes a server 210, at least one labeling device 240, an intermediate device 220, and at least one measuring device 230.

The server 210 stores a plurality of individual parameters, and is in communication with the Internet or other communication networks. The individual parameter includes corresponding user characteristic data and device parameters, and even may include data analysis rules corresponding to the user characteristic data.

The labeling device 240 carried by a user can be designed into the shape of a bracelet worn on the wrist or a necklace hanging around the neck according to the habits of different users. The labeling device 240 is used for recording a user characteristic data, i.e., a coded data or text data of the corresponding user.

The intermediate device 220, having a detection module 221 and built with a memory unit 222, is connected to the measuring device 230 through a physical circuit or wireless transmission, and meanwhile, connected to the server 210 through the Internet or other communication networks.

The intermediate device 220 detects the existence of the labeling device 240 through the detection module 221, determines a position of the labeling device 240 according to a signal response strength and a detection angle for detecting the labeling device 240, meanwhile obtains the user characteristic data, and connects the server 210, so as to download the corresponding individual parameter according to all the user characteristic data and store the parameter in the memory unit 222.

Afterward, the intermediate device 220 detects the operating status of the measuring device 230, and outputs the corresponding individual parameter to the measuring device 230 according to the user characteristic data recorded by the labeling device 240 at a particular position when it is detected that the measuring device 230 is actuated and the labeling device 240 is located at the particular position on the periphery of the measuring device 230.

When it is determined that above two labeling devices 240 are located at the particular position, the intermediate device 220 determines and outputs the related individual parameter in the following manner.

1. The individual parameter corresponding to the user characteristic data of the labeling device 240 with a dwell time in accordance with the measuring time is output.

2. The measuring device 230 is provided with a detection module 231 having a detection range smaller than that of the intermediate device 220. The detection range of the detection module 231 only covers the periphery of the measuring device 230 or extends in a certain direction or at a certain angle. The detection module 231 detects the existence of a labeling device 240 and feeds back the user characteristic data of the labeling device 240 to the intermediate device 220, such that the intermediate device 220 outputs the matching individual parameter to be set by the measuring device 230 according to the user characteristic data transmitted by the measuring device 230.

3. When detecting the existence of above two labeling devices 240, and determining one of the labeling devices 240 is located at a particular angle corresponding to the detection module 231, the detection module 231 of the measuring device 230 outputs the user characteristic data of the labeling device 240 to the intermediate device 220.

However, when actuated, the measuring device 230 obtains the individual parameter transmitted by the intermediate device 220 for setting. Then, the parameter is measured by the measuring device 230 to generate a related measurement data, and afterward the measurement data is fed back to the intermediate device 220. The intermediate device 220 integrates the measurement data with the previously analyzed user characteristic data, and feeds back the data to the server 210 for subsequent analysis.

However, when it is unable to determine the current user of the measuring device 230, the intermediate device 220 records all the user characteristic data of the labeling devices 240 at the particular position, and outputs the user characteristic data and measurement data to the server 210. The server 210 performs back-end analysis with all the individual parameters or the measurement data corresponding to the user characteristic data, so as to determine the user most likely to adopt the measuring device 230.

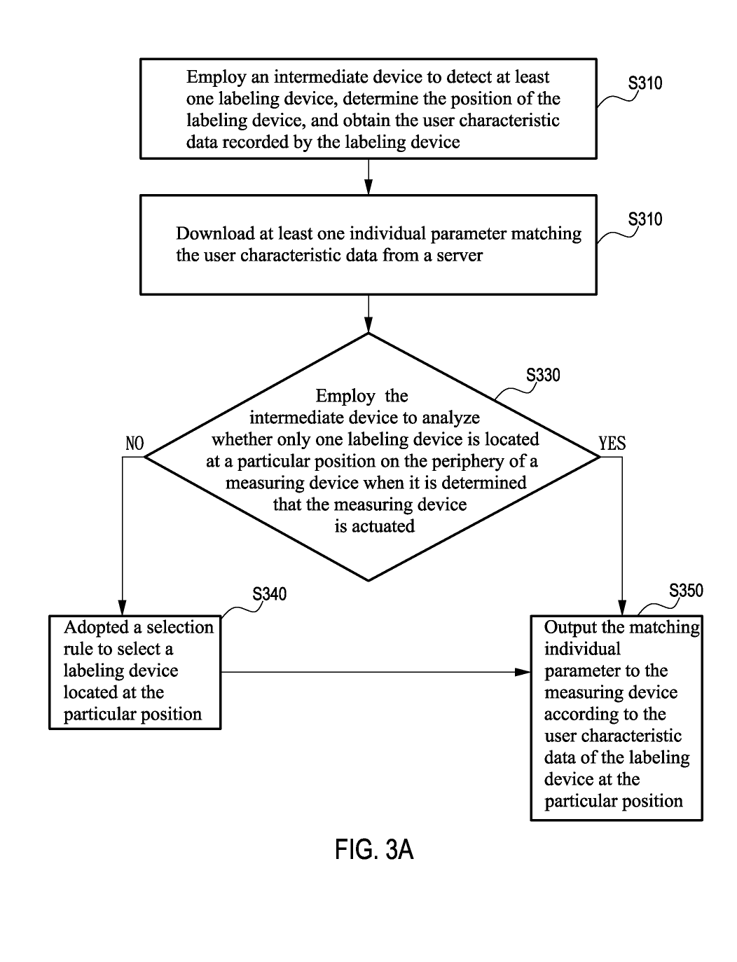

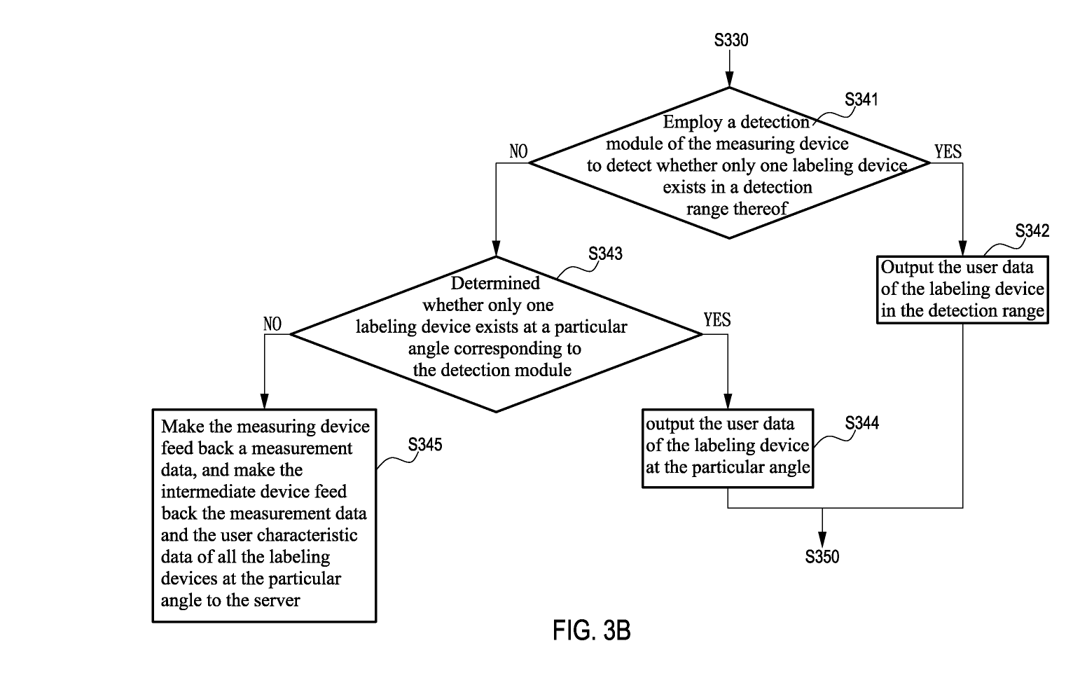

FIGS. 3A and 3B are respectively a schematic flow chart and a schematic partial flow chart of the method according to the first embodiment of the present invention, and FIGS. 2A and 2B can be together referred to for comprehension. The method includes the following steps.

In Step S310, an intermediate device 220 is used to detect at least one labeling device 240, determine the position of the labeling device 240, and obtain the user characteristic data recorded by the labeling device 240.

The intermediate device 220 first employs the detection module 221 to detect all the labeling devices 240 in the detection range thereof, and if the detection result is positive, sequentially determine the position of each labeling device 240.

In the determination process, first the intermediate device 220 is employed to analyze a signal response strength for detecting the labeling device 240, so as to determine a space between the labeling device 240 and the intermediate device 220. Then, the intermediate device 220 is employed to analyze a signal feedback direction for detecting the labeling device 240, so as to determine a detection angle of the intermediate device 220 for detecting the labeling device 240. Finally, the position of the labeling device 240 is analyzed according to the space and the detection angle. In addition, the processes of determining the space and the detection angle can be switched, instead of being limited to the above sequence. After that, the detection module 221 reads and stores all the user characteristic data recorded by the labeling device 240.

In Step S320, at least one individual parameter matching the user characteristic data is downloaded from a server 210. A conversation is built between the intermediate device 220 and the server 210, for comparing the user characteristic data with the data stored in the server 210, obtaining the individual parameter matching the user characteristic data, and downloading and storing all the individual parameters into the memory unit 222 of the intermediate device 220.

In addition, the storage capacity of the memory unit 222 is detected before storing the individual parameters. If it is determined that the storage space of the memory unit 222 is sufficient, all the individual parameters transmitted by the server 210 are stored; otherwise, a parameter update operation will be performed on the memory unit 222.

The parameter update operation can be performed in the following three manners.

1. The intermediate device 220 is employed to analyze all the stored individual parameters, and determine whether a storage time of the originally stored individual parameters exceeds a storage term. If yes, the intermediate device 220 deletes the individual parameters exceeding the storage term.

2. When storing the individual parameters, the intermediate device sets each individual parameter with an authority. When it is determined that the storage space of the memory unit 222 is insufficient, the intermediate device deletes the individual parameter with the lowest authority in the memory unit 222.

3. The intermediate device 220 determines all the detected labeling devices 240. If any of the labeling devices 240 moves out of a detection range of the intermediate device 220, the intermediate device 220 deletes the corresponding individual parameter of the labeling device 240.

Afterward, in Step S330, the intermediate device 220 analyzes whether only one labeling device 240 is located at a particular position on the periphery of a measuring device 230 when it is determined that the measuring device 230 is actuated. This step mainly determines the user of the measuring device 230 according to the positions of all the labeling devices 240. If any one of the labeling devices 240 is located at the particular position on the periphery of the measuring device 230, the user at the particular position must be the user of the measuring device 230. In addition, the particular position is a position at which the labeling device 240 surely dwells when the user employs the measuring device 230. For example, if the measuring device 230 is a blood-pressure meter, the particular position is in a certain range right ahead of the blood-pressure meter.

When the intermediate device 220 analyzes that above two labeling devices 240 are located at the particular position, a selection rule is adopted to select a labeling device 240 located at the particular position (Step S340). The selection rule is illustrated as follows.

1. A dwell time of each labeling device 240 at the particular position is calculated, and the labeling device 240 with the dwell time most matching the measuring time is selected.

2. A detection module 231 of the measuring device 230 is used to detect whether only one labeling device 240 exists in a detection range thereof (Step S341). If yes, the labeling device 240 in the detection range is a labeling device 240 carried by the user of the measuring device 230, and the measuring device 230 outputs the user characteristic data of the labeling device 240 in the detection range (Step S342). Otherwise, it is determined whether only one labeling device 240 exists at a particular angle corresponding to the detection module 231 (Step S343). When the measuring device 230 is employed by the user, the labeling device 240 is surely located at a detection angle of the measuring device 230, and the detection angle is the aforementioned particular angle. If a single labeling device 240 exists at the particular angle, the measuring device 230 outputs the user characteristic data of the labeling device 240 at the particular angle (Step S344). If multiple labeling devices 240 exist, the measuring device 230 feeds back a measurement data, and the intermediate device 220 feeds back the measurement data and the user characteristic data of all the labeling devices 240 at the particular angle to the server 210 (Step S345).

Finally, the matching individual parameter is output to the measuring device 230 according to the user characteristic data of the labeling device 240 at the particular position (Step S350).

If the user of the measuring device 230 is determined, the intermediate device 220 determines whether the matching individual parameter has been downloaded. If yes, the intermediate device 220 outputs the individual parameter matching the user characteristic data to the measuring device 230; otherwise, the intermediate device 220 downloads the matching individual parameter from the server 210 and outputs the individual parameter to the measuring device 230.

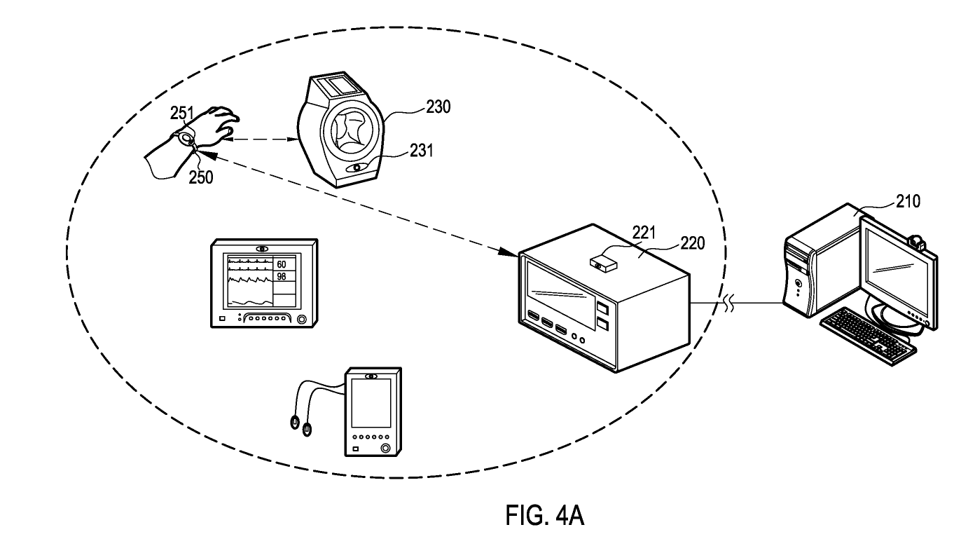

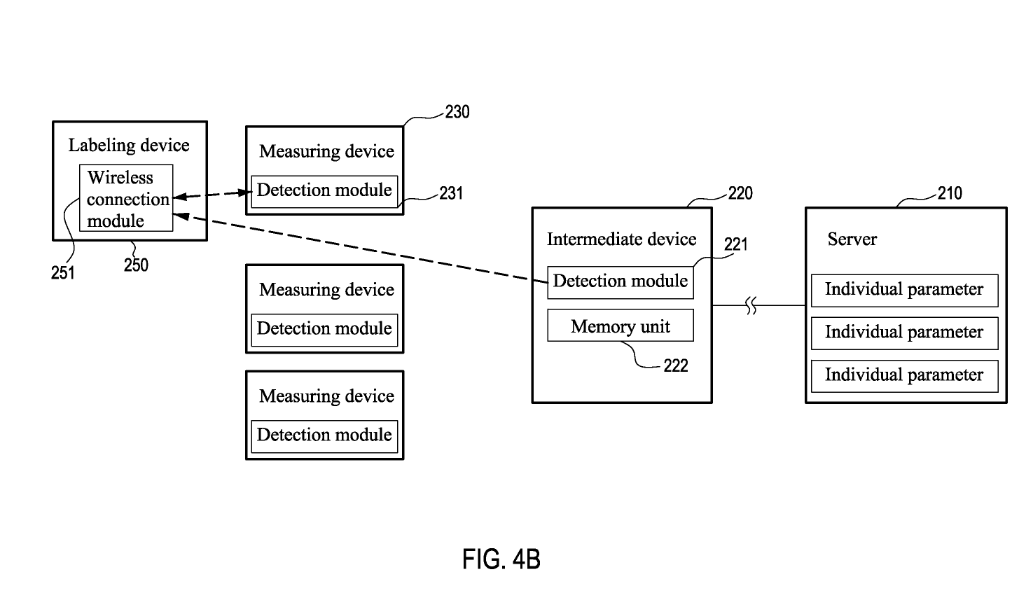

Together referring to FIGS. 4A and 4B, a schematic architectural view and a schematic block diagram of the system according to a second embodiment of the present invention are shown respectively. Different from the first embodiment, in the second embodiment, the labeling device 250 is built with a wireless connection module 251, the intermediate device 220 is not physically connected to the measuring device 230, and the intermediate device 220 and the measuring device 230 respectively have a detection module (221, 231).

The detection range of the detection module 231 in the measuring device 230 is limited to the periphery of the measuring device 230, and the detection range of the detection module 221 in the intermediate device 220 covers the detection range of the detection module 231 in the measuring device 230. The labeling device 250 of the user is both located in the detection range of the detection module 221 in the intermediate device 220 and that of the detection module 231 in the measuring device 230, so as to build a wireless connection channel to communicate the intermediate device 220 with the measuring device 230. The wireless connection technique employed by the wireless connection module 251 may be a ZigBee, blue-tooth, or infrared signal transmitting/receiving technique. The recorded user characteristic data is read by a radio frequency identification (RFID) technique or any other wireless transmission technique capable of transmitting a user ID.

The intermediate device 220 detects the action of the measuring device 230 through the wireless connection channel, and wirelessly broadcasts an actuation signal to the wireless connection module 251 when the measuring device 230 is actuated. The wireless connection module 251 forwards the actuation signal and the user characteristic data of the labeling device 250 to the intermediate device 220, and the intermediate device 220 feeds back the matching user characteristic data to the measuring device 230.

When detecting above two labeling devices 250 exist on the periphery, the detection module 231 of the measuring device 230 broadcasts the actuation signal to all the wireless connection modules 251, and the wireless connection modules 251 respectively feed back the actuation signal and the user characteristic data. The intermediate device 220 analyzes whether the user characteristic data is corresponding to the labeling device 250 at the particular position, so as to determine whether to output the matching individual parameter to the measuring device 230.

Or, the detection module 231 of the measuring device 230 determines which detection angle for detecting the labeling devices 250 matches the particular angle, so as to transmit the actuation signal to the wireless connection module 251 of the labeling device 250 at the particular angle.

However, when neither the detection module 231 of the measuring device 230 nor the detection module 221 of the intermediate device 220 is able to determine the user of the measuring device 230, the intermediate device 220 makes the measuring device 230 to feed back the measurement data, and transmits all the user characteristic data together with the measurement data to the server 210 for performing the back-end analysis.

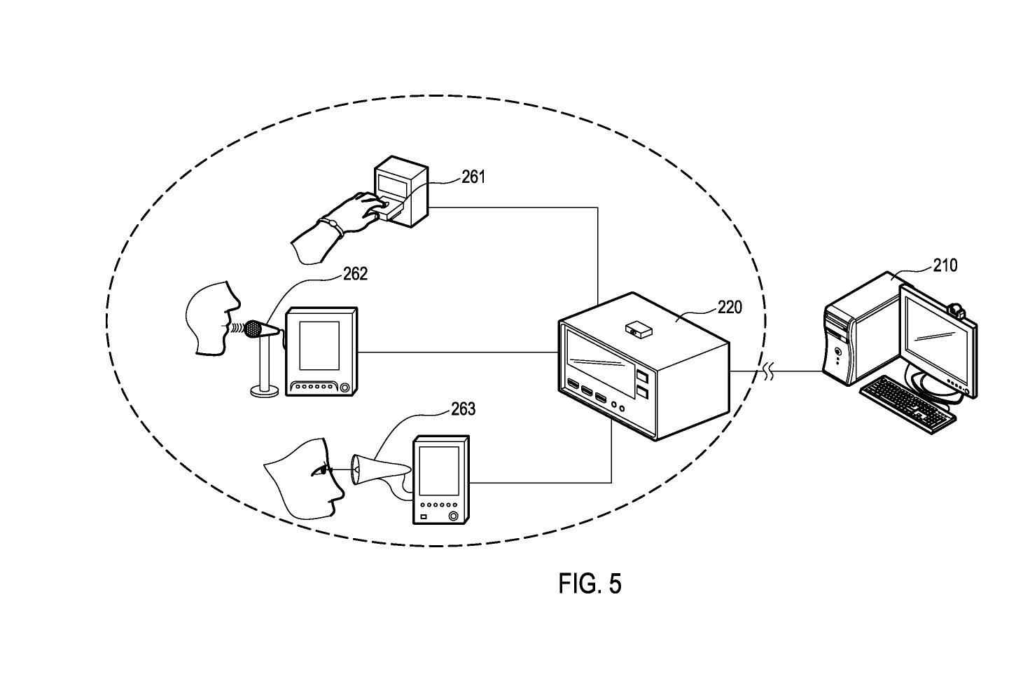

Referring to FIG. 5, a schematic structural view of the system according to a third embodiment of the present invention is shown. Different from the first embodiment, in the third embodiment, the measuring device 230 is provided with a human-machine module, for inspecting a physiological characteristic of the user to form a user characteristic data, and transmitting the characteristic value to the intermediate device 220. The intermediate device 220 outputs the individual parameter matching the user characteristic data to the measuring device 230, for performing the device setting operation.

The human-machine module may be a fingerprint identification module 261, a sound identification module 262, or a retina identification module 263, and thus the user characteristic data compared by the intermediate device 220 are characteristic values of the fingerprint, sound wave, or retina of the user obtained by the human-machine module. Moreover, the human-machine module can be operated by the above selection rule, thereby enhancing the adaptability of the system.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A system for preloading individual parameters, comprising:
a server, for storing a plurality of individual parameters;
at least one labeling device, for recording a user characteristic data;
at least one measuring device, for obtaining an individual parameter corresponding to the user characteristic data for subsequent setting when being actuated; and
an intermediate device, for detecting the labeling device to obtain the user characteristic data, then acquiring the individual parameter matching the user characteristic data from the server, and analyzing the user characteristic data of the labeling device at a particular position when detecting that the measuring device is actuated and the labeling device is located at the particular position on the periphery of the measuring device, so as to output the individual parameter corresponding to the user characteristic data.

2. The system for preloading individual parameters according to claim 1, wherein the intermediate device determines a position of the labeling device according to a signal response strength and a detection angle for detecting the labeling device.

3. The system for preloading individual parameters according to claim 2, wherein when it is determined that above two labeling devices are located at the particular position, the intermediate device calculates a time the labeling devices dwell at the particular position, so as to output the individual parameter corresponding to the user characteristic data of the labeling device with a dwell time in accordance with a measuring time.

4. The system for preloading individual parameters according to claim 2, wherein the measuring device further comprises a detection module for detecting the labeling device and feeding back the corresponding user characteristic data to the intermediate device, and when it is determined that above two labeling devices are located at the particular position, according to the user characteristic data transmitted by the detection module, the intermediate device outputs the individual parameter corresponding to the user characteristic data.

5. The system for preloading individual parameters according to claim 4, wherein after the detection module detects above two labeling devices and determines one of the labeling devices is located at a particular angle corresponding to the detection module, the detection module outputs the user characteristic data of the labeling device.

6. The system for preloading individual parameters according to claim 1, wherein the measuring device outputs a measurement data, the intermediate device outputs the user characteristic data and the measurement data to the server.

7. The system for preloading individual parameters according to claim 6, wherein when it is determined that above two labeling devices are located at the particular position, the intermediate device outputs the user characteristic data of the labeling devices and the measurement data to the server.

8. The system for preloading individual parameters according to claim 1, wherein when it is determined that any of the detected labeling devices moves out of a detection range of the intermediate device, the intermediate device deletes the corresponding individual parameter of the labeling device.

9. The system for preloading individual parameters according to claim 1, wherein the intermediate device further comprises a memory unit for storing the individual parameters, and the intermediate device analyzes the stored individual parameters and deletes those exceeding a storage term when it is determined that the storage space of the memory unit is insufficient.

10. The system for preloading individual parameters according to claim 1, wherein the intermediate device further comprises a memory unit for storing the individual parameters, each of the individual parameters is corresponding to an authority, and the intermediate device deletes the individual parameter with the lowest authority in the memory unit when it is determined that the storage space of the memory unit is insufficient.

11. The system for preloading individual parameters according to claim 1, wherein the labeling device further comprises a wireless connection module for building a wireless connection channel between the intermediate device and the measuring device.

12. The system for preloading individual parameters according to claim 11, wherein the detection range of the intermediate device covers the detection range of the measuring device, and the wireless connection channel is built when the intermediate device is located in the detection range of the intermediate device and the measuring device at the same time.

13. A method for preloading individual parameters, comprising:
employing an intermediate device to detect at least one labeling device, determine a position of the labeling device, and obtain a user characteristic data recorded by the labeling device;
downloading at least one individual parameter matching the user characteristic data from the server, and storing the individual parameter in the intermediate device;
employing the intermediate device to analyze whether only one labeling device is located at a particular position on the periphery of a measuring device when it is determined that the measuring device is actuated, wherein if no, a selection rule is adopted to select the labeling device located at the particular position; and
outputting a matching individual parameter to the measuring device according to the user characteristic data of the labeling device at the particular position.

14. The method for preloading individual parameters according to claim 13, wherein the step of determining the position of the labeling device comprises:
employing the intermediate device to analyze a signal response strength for detecting the labeling device, so as to determine a space between the labeling device and the intermediate device;
employing the intermediate device to analyze a signal feedback direction for detecting the labeling device, so as to determine a detection angle of the intermediate device for detecting the labeling device; and
analyzing the position of the labeling device according to the space and the detection angle.

15. The method for preloading individual parameters according to claim 13, wherein the step of adopting a selection rule to select the labeling device located at the particular position comprises:
Calculating a time the labeling devices dwell at the particular position; and
selecting the labeling device with a dwell time in accordance with a measuring time.

16. The method for preloading individual parameters according to claim 13, wherein the step of adopting a selection rule to select the labeling device located at the particular position comprises:
employing a detection module of the measuring device to detect whether only one labeling device is located in a detection range thereof;
if yes, outputting the user characteristic data of the labeling device in the detection range; and
if no, determining whether only one labeling device is located at a particular angle corresponding to the detection module, so as to decide whether to output the user characteristic data of the labeling device corresponding to the particular angle.

17. The method for preloading individual parameters according to claim 16, wherein the step of determining whether only one labeling device is located at a particular angle corresponding to the detection module comprises:
if yes, outputting the user characteristic data of the labeling device corresponding to the particular angle; and
if no, requiring the measuring device to feed back a measurement data, and employing the intermediate device to feed back the measurement data and the user characteristic data of the labeling devices at the particular angle to the server.

18. The method for preloading individual parameters according to claim 16, wherein the step of outputting the matching individual parameter to the measuring device according to the user characteristic data of the labeling device at the particular position comprises:
determining whether the matching individual parameter has been downloaded, and if yes, outputting the individual parameter matching the user characteristic data to the measuring device; if no, downloading the matching individual parameter from the server and outputting the matching individual parameter to the measuring device.

19. A recording medium, for recording electronic device readable program codes, wherein the program codes perform a method for preloading individual parameters, and the method comprises:
employing an intermediate device to detect at least one labeling device, determine a position of the labeling device, and obtain a user characteristic data recorded by the labeling device;
downloading at least one individual parameter matching the user characteristic data from the server, and storing the individual parameter in the intermediate device;
employing the intermediate device to analyze whether only one labeling device is located at a particular position on the periphery of a measuring device when it is determined that the measuring device is actuated, wherein if no, a selection rule is adopted to select a labeling device located at the particular position; and
outputting the matching individual parameter to the measuring device according to the user characteristic data of the labeling device at the particular position.

20. The recording medium according to claim 19, wherein the step of determining the position of the labeling device comprises:
employing the intermediate device to analyze a signal response strength for detecting the labeling device, so as to determine a space between the labeling device and the intermediate device;
employing the intermediate device to analyze a signal feedback direction for detecting the labeling device, so as to determine a detection angle of the intermediate device for detecting the labeling device; and
analyzing the position of the labeling device according to the space and the detection angle.

21. The recording medium according to claim 19, wherein the step of adopting a selection rule to select the labeling device located at the particular position comprises:
calculating the time the labeling devices dwell at the particular position; and
selecting the labeling device with a dwell time in accordance with the measuring time.

22. The recording medium according to claim 19, wherein the step of adopting a selection rule to select the labeling device located at the particular position comprises:
employing a detection module of the measuring device to detect whether only one labeling device is located in a detection range thereof;
if yes, outputting the user characteristic data of the labeling device in the detection range; and
if no, determining whether only one labeling device is located at a particular angle corresponding to the detection module, so as to decide whether to output the user characteristic data of the labeling device corresponding to the particular angle.

23. The recording medium according to claim 22, wherein the step of determining whether only one labeling device is located at a particular angle corresponding to the detection module further comprises:
if yes, outputting the user characteristic data of the labeling device corresponding to the particular angle; and
if no, requiring the measuring device to feed back a measurement data, and employing the intermediate device to feed back the measurement data and the user characteristic data of the labeling devices at the particular angle to the server.

24. The recording medium according to claim 19, wherein the step of outputting the matching individual parameter to the measuring device according to the user characteristic data of the labeling device at the particular position comprises:
determining whether the matching individual parameter has been downloaded, and if yes, outputting the individual parameter matching the user characteristic data to the measuring device; if no, downloading the matching individual parameter from the server and outputting the matching individual parameter to the measuring device.
